(19) United States
(12) Patent Application Publication
(10) Pub. No.: US 2014/0279105 A1
(43) Pub. Date: Sep. 18, 2014

(54) Method for Vehicle Sale or Lease

(71) Applicant: ESQUARE AUTO INC., Campbell, CA (US)

(72) Inventors: Eric Winokur, Los Gatos, CA (US); Andy Schwaderer, San Carlos, CA (US)

(73) Assignee: ESQUARE AUTO INC., Campbell, CA (US)

(21) Appl. No.: 13/802,550

(22) Filed: Mar. 13, 2013

(51) Int. Cl. G06Q 30/06

(52) U.S. Cl. CPC G06Q 30/0611
USPC 705/21; 705/26.4

(57) ABSTRACT

Disclosed herein is a method for a sale or lease of a vehicle. The method is performed by a software application, and the software application's primary focus is facilitating the negotiation. The method includes various steps. One step is receiving confirmation that an in-person meeting between a merchant representative and a buyer has occurred. Another step is receiving inputs from the merchant representative who is initiating a transaction. These inputs being received are from a device used by the merchant representative, and the transaction is for the sale or the lease of the vehicle. Yet another step is receiving inputs for processing the transaction from both the merchant representative and the buyer. These inputs for processing the transaction facilitate a negotiation on sale or lease terms between the merchant representative and the buyer.

### BACKGROUND

New franchise and used vehicle dealers face numerous challenges, including significantly decreasing front end revenues. The decrease in front end profitability can be largely attributed to the internet, exorbitant costs for lead generation, maintaining legacy systems and operational inefficiencies within sales processes and deficiencies amongst sales departments. The current dealer sales process is adversarial and filled with high pressure tactics, where the consumer is subjected to a standard one size fits all sales method and the sale is ‘pushed’ on the consumer. The consumer is also subjected to the retailers marketing, messaging, and branding at the point of sale. This limits or eliminates the consumer's purchasing freedom. Consequently, the consumer loses attention and engagement during the sale process.

Products exist in the marketplace as static tools to assist in the sales process for the vehicle dealers. The core focus of these products addresses only components of the sales cycle such as converting paper forms to electronic data, loan approval and/or credit reporting solutions. Furthermore, these products are for the direct use of the dealership and mainly benefit the dealership.

### SUMMARY

Disclosed herein is a method for a sale or lease of a vehicle. The method is performed by a software application, and the software application's primary focus is facilitating the negotiation. The method includes various steps. One step is receiving confirmation that an in-person meeting between a merchant representative and a buyer has occurred. Another step is receiving inputs from the merchant representative who is initiating a transaction. These inputs being received are from a device used by the merchant representative, and the transaction is for the sale or the lease of the vehicle. Yet another step is receiving inputs for processing the transaction from both the merchant representative and the buyer. These inputs for processing the transaction facilitate a negotiation on sale or lease terms between the merchant representative and the buyer.

The present invention is better understood upon consideration of the detailed description below in conjunction with the accompanying drawings and claims.

### BRIEF DESCRIPTION OF DRAWINGS

FIG. 1 depicts example input and output options used in the method;

FIG. 2 illustrates an overview flowchart for the module and dashboard technology for an example environment and example interactions;

FIG. 3 is an example environment for the method at a vehicle dealership location;

FIG. 4 is an example virtual environment diagram for the method;

FIG. 5 details a flowchart of an example embodiment for the pre-sale portion of the sales process;

FIG. 6 illustrates an example of the pre-delivery process;

FIG. 7 shows a flowchart for an example embodiment of the ezGreet™ module;

FIG. 8 depicts an example login screen for the user or merchant representative;

FIG. 9 shows an example of a main menu for the ezGreet™ module;

FIG. 10 is an example of data collected;

FIG. 11 illustrates an example for using a drop down menu;

FIG. 12 demonstrates an example of consumer prompted questions;

FIG. 13 illustrates a flowchart for an example embodiment of the ezInternet™ module;

FIG. 14 is a flowchart for an example of an online consumer portal;

FIG. 15 illustrates a flowchart for an example embodiment of the ezCarBuyer™ module;

FIG. 16 is a flowchart for an example embodiment of the ezPencil™ module;

FIG. 17 shows an example embodiment of the negotiation between the buyer and merchant representative;

FIG. 18 is an example of a comparison chart;

FIG. 19 is an example of a four square worksheet;

FIG. 20 is a flowchart for an example embodiment of the ezPre-Fi™ module;

FIG. 21 depicts a flowchart for an example embodiment of the ezMenu™ module;

FIG. 22 shows a flowchart for an example embodiment of the ezDelivery™ module;

FIG. 23 illustrates a flowchart for an example embodiment of the ezGreet™ module; and

FIG. 24 illustrates a flowchart for an example embodiment of the ezService™ module.

### DETAILED DESCRIPTION

The present invention is a method for a sale or lease of a vehicle. The method is performed by a software application, and the software application's primary focus is facilitating the negotiation. The method includes various steps. One step is receiving confirmation that an in-person meeting between a merchant representative and a buyer has occurred. Another step is receiving inputs from the merchant representative who is initiating a transaction. These inputs being received are from a device used by the merchant representative, and the transaction is for the sale or the lease of the vehicle. Yet another step is receiving inputs for processing the transaction from both the merchant representative and the buyer. These inputs for processing the transaction facilitate a negotiation on sale or lease terms between the merchant representative and the buyer.

In one embodiment, the negotiation is primarily driven by the buyer. The sale or lease terms may include loan amount, finance arrangement, trade-in value, amount of cash deposit, extended warranties, accessories, parts, service, installations, repair work, maintenance or insurance. In one embodiment, the software application interface is a web browser or smartphone application. The device may be an internet enabled device such as a smartphone, a tablet, a handheld computing device, a kiosk, a laptop or a desktop computer.

In one example, the merchant representative is located at a point of sale and the in-person meeting occurs at a point of sale. In another example, the inputs are primarily provided at the point of sale.

In one embodiment, the method further comprises collecting data from the buyer and then, by utilizing psycho-analytics or logic based artificial intelligence, determine a need of the buyer based at least in part on the data which is identified. In another embodiment, iris recognition or multi-biometrics is used to identify a need or desire of the buyer based on the data. The data is analyzed and a product for sale or lease based on the data is identified. The product for the buyer is displayed and reports for the merchant representative based at least in part on the data are created. The collecting of the data occurs in real time and occurs at a point of sale. The inputs are primarily provided electronically, online, wirelessly or telephonically.

Traditional sales methods in the automotive industry provide limited to no process control to the merchant representative, or dealer, at the dealership to allow for a seller driven sale. Most consumers dread the “in-your-face/hard sell” approach. In contrast, this method focuses on the needs, interests and behaviors of the consumer throughout the entire vehicle purchase cycle. Consumers can be monitored starting from their initial research, through driving home in their newly purchased vehicle from the dealership, and beyond. Furthermore, the method provides efficiency, control and visibility over the complete car buying experience for both the dealer and consumer in real time.

The present method is utilized by both the consumer and merchant representative through various technologies such as human input, software, hardware, audio, video, psychological and/or statistical analysis, probability modeling, databases, artificial intelligence, iris recognition, multi-biometrics, Internet, cellular and wireless technologies to provide a robust and comprehensive sales method. FIG. 1 depicts example input options used in the method. In some embodiments, original equipment manufacturers (OEM) and any other business subscribers may also use the method. Leveraging the various technologies enables the consumer and merchant representative to effectively engage each other throughout all components of the sales cycle, lending to a cohesive and successful purchase/sale.

For the merchant representative, embodiments allow for improvement of operational efficiencies and workflow, including improved streamlining for the sales and delivery process. This may result in increasing sale revenue, lowering operational expenses, and improving Customer Satisfaction Index (CSI). Additionally, the system may act as a line of defense for dealers against salesperson and/or customer fraud or Office of Foreign Assets Control (OFAC) red flag compliance. More efficiency coupled with greater customer satisfaction will produce more sales opportunities.

On the consumer side, the consumer can empower themselves to self-drive the purchase process thereby eliminating personal insecurities in dealing with a third party or salesperson. As a result, the consumer may drive the sale and make a more informed purchase decision. This increases consumer satisfaction and delivers a positive purchase process perception. Overall, by using this method, CSI, consumer retention and consumer engagement may improve creating a positive purchasing environment and experience.

The method includes two platforms that are interdependent of each other, the back-end dashboard and the consumer interface. In one embodiment, the consumer interface may be a mobile application. Both platforms utilize the same underlying technology but provide a subset of features and functionality based on, for example, open source technologies and internet development practices.

In one example, data is stored in relational databases, located either locally or remotely, with the service provider providing replication and read-only database instances. Data transmitted is load balanced and encrypted using Secure Sockets Layer (SSL) technology. FIG. 2 illustrates an overview flowchart for the module and dashboard technology for an example environment and example interactions between the consumer, retailer and manufacturer. The consumer may be referred to as a buyer or customer and is a person who buys or leases a vehicle, parts, accessories or service. The retailer may be referred to as manufacturer, dealer, dealership, salesperson or merchant representative and is the person or entity that sells or leases a vehicle.

The dashboard may be configured differently for each user, with secure access control based on the user type such as dealership, salesperson, data subscriber or the like. In one embodiment, the back-end dashboard is for use by the merchant representative or dealership personnel. This may be a web based tool providing a view into the sales process, related employee productivity and related employee activity. It is designed to be used from any type of internet enabled device such as a smartphone, a tablet, a laptop, a handheld computing device, a kiosk, or a desktop computer.

The consumer interface provides a sales process that engages both the consumer and merchant representative. The consumer interface is a combination of native mobile and web based applications that may be used from any type of internet enabled device including a smartphone, a tablet, a laptop, a kiosk or a desktop computer. Data is collected in real time such as consumer buyer behavior, psychology, patterns, demands, desires, thoughts, time tracking and geographical tracking. This data can be utilized by the dealership and OEMs to make changes to internal processes including production schedules, product design, deliverables, advertising, marketing, inventory and shipping schedules to better serve a target audience. FIG. 3 is an example environment for the method at a vehicle dealership location depicting the dealership with a local server, WiFi but no cellular service. In another embodiment, the dealership may have a local server, WiFi and cellular service. In yet another embodiment, the dealership may have a cloud server, WiFi but no cellular service. In a further embodiment, the dealership may have a cloud server, WiFi and cellular service. Depending on the mode of operation, the internet enabled device may be used inside or outside of the dealership. Other configurations may also be employed.

In one embodiment, the method utilizes hardware and software technologies to execute a modular sales process, breaking the sales process down into individual segments. In this embodiment, each segment of the sales process may be assigned a product module such as ezDashboard™, ezGreet™, ezCarBuyer™, eSquare®, eQual™, ezPencil™ ezPre-FI™, ezMenu™, ezDelivery™, ezLobby™, ezParts™, ezService™, ezBeBack™, ezAccess™ ezReporting™ and ezMonitoring™. In this embodiment, the modules are interchangeable and communicate with one another, a central database and a subscriber dashboard. An example of this embodiment and the various possible modules and technologies is provided below.

The modules formulate the method by collecting data from the consumer. The modules then use psycho-analytics or logic based artificial intelligence to identify a need of the consumer based on the data. In another embodiment, iris recognition or multi-biometrics is used to identify a need or desire of the buyer based on the data. The data is analyzed and a product for sale or lease based on the data is identified. The product for the consumer is displayed and reports are created for the merchant representative based on the data. The collecting of the data occurs in real time and occurs at a point of sale.

These modules gather data and information directly from the consumer during engagement in the sales cycle, either at the dealership or on the internet. The modules also lead the consumer down a predetermined “purchase path,” using psycho-analytics and logic based artificial intelligence, in order to facilitate allowing the consumer to identify and purchase what they want. In another embodiment, iris recognition or multi-biometrics is used to identify a need or desire of the buyer based on the data. The method also allows for the analysis of individual consumer data, so that if at the point of purchase should the consumer determine the product is not suitable, the method will automatically produce alternative suggestions and suitable solutions.

The method allows for two-way communication between the consumer and merchant representative. This open line of communication will eliminate the need for pushy sales personnel and allow the consumer to directly communicate with the decision maker in the dealership establishment. The salesperson becomes a consumer advocate and moves away from the negative stigma of being the “car salesperson”.

Because this is a modular process, the method may be utilized in a variety of environments, for example, retail, medical, housing lending, or vehicle. Vehicles are devices whose main purpose may be used to transport cargo, human or otherwise, in commercial or non-commercial applications. Examples include vehicles of or having at least one wheel, utility vehicles, all-terrain vehicles (ATV), on-road vehicles, off-road or vehicles, watercraft, aircraft, or the like.

The platforms for the method, the back-end dashboard and the consumer facing application, utilize the same underlying technology but provide a unique subset of features and functionality. The platforms are based on open source technologies and internet development practices. FIG. 4 is an example virtual environment diagram for the method. The data is stored in MySQL relational databases running the Amazon Web Services (AWS) Relational Database Service (RDS) with multi-AZ deployments. The master and slave functions are separated into different available zone while the RDS provides master-slave replication and read-only database instances.

The front-end servers utilize AWS Elastic Compute Cloud (EC2) instances as the computing core. Amazon Linux distribution is used to provide a stable, secure and high performance execution environment. Amazon EC2 provides N+1 redundancy and monitoring to network related services.

The data transmitted over the internet is load balanced and encrypted using Secure Sockets Layer (SSL) technology. A public/private key pair from a provider is applied to an AWS load balancer that handles the termination of SSL connections via a port from a web browser or mobile application. The load balancer then distributes requests to web servers based on browser specific session information generated from the application of the method.

Static data, for example, Cascading Style Sheets (CSS), JavaScript and binary images are stored in a Content Distribution Network (CDN). The CDN allows the method to push static content to the edge of the Internet thus speeding the delivery of static content to the application request.

The front-end web and application servers utilize web server technology from Apache and PHP. PHP is an open-source server-side scripting language designed for Web development to produce dynamic Web pages. Other technologies include simple shell scripts used to perform administrative tasks and the AWS scripting language.

Both the front-end web application and back-end dashboard are written using the Zend Studio PHP Framework and Zend Guard application encryption technology. Zend Studio provides a development environment for creating object oriented Model View Controller (MVC) products from PHP. The development environment includes non-PHP objects such as CSS, JavaScript and binary images. The written code written is encrypted into a binary object which is compiled and executed by the front-end web server. The development code is backed up and managed with source control which in turn is managed in a subversion repository.

The ezDashboard™ module is the management console control center for the dealership and utilized by the merchant representative, salesperson, or any other data subscriber. It operates as the main hub and ‘brain’ for all business users. It is an internet enabled device which may include a smartphone, a tablet, a handheld computing device, a kiosk, a laptop or a desktop computer. The ezLobby™ is the kiosk based in the lobby/waiting area for use by the consumer.

FIG. 5 details a flowchart of an example embodiment for the pre-sale portion of the sales process for either a new or used vehicle. The pre-sale 500 starts at step 502 with the merchant representative meeting and greeting the consumer. In one embodiment, this occurs on-site at the dealership or at the point of sale. Here, introductions are made, inventory is browsed and data is researched to understand the needs of the consumer. A test drive may be conducted then the trial is closed. The consumer may accept or reject the perspective vehicle. This may be an iterative process.

Step 504 is the work up phase. Here, the customer provides necessary information in order for the merchant representative to determine the price information such as new vehicle cost, possible trade-in value, down payment options, monthly payment, trade appraisal and ancillary products. These numbers are then presented to the customer. The merchant representative also gathers other information including credit application, driver's license, insurance card and registration for trade from the customer. If a trade-in appraisal is necessary, the customer may perform a virtual walk around of the vehicle for trade-in using ‘pimple technology’. Pimple technology provides an electronic pictorial of a vehicle for the customer to indicate with red dots defects on the actual vehicle for trade-in. The merchant representative performs a walk around of the vehicle to be traded in and ensures a manager performs a walk around as well. All documentation is written up and a test drive is conducted.

The desking/pencil phase occurs at step 506. The consumer's credit is checked and reviewed. The particular lender for submission is identified. The consumer is presented with the first pencil opportunity for negotiation. The terms of sale of the vehicle is either accepted or rejected by the consumer. This may be an iterative negotiation process so that the consumer is presented with a second, third, fourth or more pencil opportunity. The process may be repeated until the consumer accepts or finally rejects the purchase.

At step 508, if the deal has been accepted by the consumer, the paperwork is completed, the deal jacket is started and the pre-financing module is also started. The process moves to pre-delivery. In another embodiment, the pre-sale portion of the sales process for either a new or used vehicle may occur virtually such as through the Internet, or telephonically.

FIG. 6 illustrates an example of the pre-delivery process 600 for the method. At step 602, the finance and insurance process begins. The documents and menus are prepped and the warranty information, gap and ancillary are presented. Education for the customer may be presented and the loan is reviewed and may be modified. This may be accepted or rejected by the customer. Based on various feedback, the documents may also need to be redrafted or revised.

Step 604 is the get ready work phase. An In/Out form indicating particulars of the trade-in vehicle, if applicable, and the details of the outgoing inventory, or purchased vehicle is generated. All customer paperwork is gathered and completed, the deal jacket is established and the vehicle is detailed and filled with fuel. The vehicle may be registered as necessary with entities such as Customer Relationship Management (CRM), OEM, satellite radio providers, navigation system providers or a service department.

At step 606, the vehicle is delivered to the customer. The customer has the opportunity to do a vehicle walk around inspection then instructions and education are provided by the merchant representative about the vehicle such as Bluetooth features, satellite radio operation, navigation system functions and the like. The consumer may provide social media feedback and fill out a CSI survey. A service appointment reminder card may be given to the customer before leaving the dealership in the newly purchased vehicle.

Step 608 allows for follow up such as correspondence by the merchant representative to the customer. This may be in the form of emails or telephone calls and may occur at various time periods after the purchase. In another embodiment, the pre-delivery portion of the sales process for either a new or used vehicle may occur virtually such as through the Internet, or telephonically.

The method is utilized when a consumer is interested in purchasing a new or used vehicle. In one embodiment, the consumer may start the process not physically at the dealership, but by utilizing the dealer's website. In another embodiment, the consumer may start the process when physically onsite at the dealership. FIG. 7 shows a flowchart for an example embodiment of the ezGreet™ module for a new/used vehicle consumer 700 which occurs onsite at the dealership. In a non-limiting example, a consumer enters a dealership with or without an appointment, interested in purchasing a new or used vehicle. The merchant representative or salesperson meets and greets the consumer. In one embodiment, this occurs on-site at the dealership or at the point of sale. The merchant representative starts the consumer engagement tool, the ezGreet™ module.

The ezGreet™ module is a series of prompted questions over several screens on a device to meet the consumer, understand the needs of the consumer and log the visit of the consumer. To aid the user through the process, drop-down menus guides the user through a series of questions. In other embodiments, a software wizard tool or setup assistant may be used. Other commercially available techniques may be used to walk the user through the options.

In an alternative embodiment, GPS tracking may be used for customer and/or salesperson activity on or off of the dealership lot such as during test drives or for simply locating a salesperson. GPS technology is also utilized to locate inventory. For example, GPS implementations can locate inventory based on customer inputs and psycho-analytics, logic based intelligence, iris recognition and/or multi-biometrics.

FIG. 8 depicts an example login screen for the user or merchant representative. After logging in, FIG. 9 shows an example of the main menu for the ezGreet™ module. In one embodiment, ‘new customer’ is chosen. Referring again to FIG. 7, the merchant representative collects data from the consumer such as name, contact information and reason for visit which is depicted in FIG. 10. FIG. 11 illustrates an example for using a drop down menu.

The consumer may answer several questions as shown in an example for FIG. 12, used to determine the needs of the consumer. The system uses the data collected and psycho-analytics, logic based artificial intelligence, iris recognition and/or multi-biometrics. In one embodiment, a suitable product is generated and displayed. This product may be located on-site or at the dealership, or may be off-site at another dealership. In another embodiment, the consumer may have preselected a product prior to the visit. In further embodiments, the consumer may scan the inventory then select a product from the inventory.

During the process, if a user times-out for less than 5 minutes, the user will be able to log back into the last known page immediately. If the user times-out for more than 5 minutes, the user will have to perform a record locator and be returned to previous work. Time, GPS, and server connection/upload continues for 10 minutes after last time-out. After 10 minutes, the system will prompt an alarm, to continue, and/or to terminate engaged function. If the user selects continue, the time-out clock resets. If the user selects terminate, the module is ended and the user is returned to the home log-on screen. Previous work and customer data is stored, logged and saved to a server.

FIG. 13 illustrates a flowchart for an example embodiment of the ezInternet™ module 1300. This is utilized when a consumer is interested in purchasing a new or used vehicle and starts the process not physically at the dealership but using the dealer's website. FIG. 14 is a flowchart for an example of an online consumer portal. This portal is a data aggregator, consumer research tool and industry website plugin. It directly integrates with the Velocity Sales Engine/Car Buyer Vault (VSE/CBV) and the entire system providing the consumer with a purchase experience from the internet to their driveway.

When the consumer is ready to purchase a vehicle, the ezCarBuyer™ module begins. FIG. 15 illustrates a flowchart for an example embodiment of the ezCarBuyer™ module 1500. This module is the pre-pencil tool used by the merchant representative and customer. In this phase, if the customer has a trade-in vehicle, a formal appraisal is requested. The appraisal may include a virtual walk around by the customer as well as an actual, live walk around by the merchant representative. Also, information is gathered and submitted about the customer including photo registration, driver's license and insurance. A credit application, if applicable, may be started. The system progresses and the customer is ready to move to the ezPencil™ module.

The ezPencil™ module is the penciling tool used to present payment options and sale terms including negotiation to the customer for a sale or lease of a vehicle. This occurs after an in-person meeting between a merchant representative and a buyer at a point of sale, or at the dealership. In another embodiment, an in-person meeting between a merchant representative and a buyer does not have to occur. Instead, the meeting between the merchant representative and the buyer may occur electronically, online, telephonically or the like. FIG. 16 is a flowchart for an example embodiment of the ezPencil™ module 1600. The merchant representative located at a point of sale, initiates a transaction by inputs and creates an offer at step 1601. The offer may be chosen from multiple offers that the system generated based on psycho-analytics, logic based intelligence, iris recognition and/or multi-biometrics or that the merchant representative created. The inputs received are from a device used by the merchant representative. The device is an internet enabled device including a smartphone, a handheld computing device, a kiosk, a tablet, a laptop or a desktop computer. The offer or transaction is for the sale or the lease of the vehicle, parts, accessories or service. Once the offer is created by the merchant representative, the customer located at the point of sale may review the offer and accept or reject at step 1602.

If the offer is rejected by the customer, at step 1604, the pencil question and answer is displayed. Inputs for processing the transaction, from both the merchant representative and the buyer, may be received where the inputs for processing the transaction facilitate a negotiation on sale or lease terms, parts, accessories or service between the merchant representative and the buyer. The provided inputs are primarily provided electronically, online, wirelessly or telephonically. At step 1606, the customer may submit responses to the merchant representative, salesperson, or sales manager in the dashboard. At step 1608, the merchant representative reviews the responses and at step 1610, may update the offer in the dashboard. This is then sent to the kiosk for customer review. The negotiation is primarily driven by the buyer and the inputs are primarily provided by the buyer at the point of sale.

FIG. 17 shows an example embodiment of the negotiation between the buyer and merchant representative. In one embodiment, the sale or lease terms include loan amount, finance arrangement, trade-in value, amount of cash deposit, extended warranties, accessories, parts, service, installations, repair work, maintenance or insurance. The numbers block 1702 is displayed on the device such as MSRP, the trade-in value, rebates, down payment and vehicle selling price. The loan options block 1704 is displayed detailing the loan payment based on various time periods of the loan. The lease options block 1706 is also displayed showing the lease payment based on various time periods of the lease.

During the negotiation, the buyer or merchant representative may change the values of the loan options block 1704 or the lease options block 1706 displayed on the device by sliding the dollar bar 1708. When this input is received by the buyer or merchant representative, a software application is executed where the software application has a primary focus of facilitating the negotiation. In one embodiment, the software application interface is a web browser or smartphone application. In this implementation, when the customer slides the dollar bar 1708, the down payment value in numbers block 1702 changes. Based on this input, the values in loan options block 1704 and the values in lease options block 1706 update accordingly in real time. The customer can now review the new scenario.

In another implementation, the merchant representative may negotiate by sliding dollar bar 1708 as well. Based on the privileges of the merchant representative, the sales price or trade-in value in numbers block 1702 or another variable may be changed. The merchant representative may also share various comparison information with the customer through the system. FIG. 18 is an example comparison chart. In this example, the monthly cost of the existing vehicle of the customer is compared to the monthly cost of the perspective new vehicle highlighting an estimated monthly savings.

Referring back to FIG. 16, the customer may accept or reject the offer at step 1602. If the customer rejects the offer, the process returns to step 1604 then continues as before with steps 1606, 1608, 1610 and 1612. At step 1602, the customer again has the option to accept or reject the offer. If the customer again rejects the offer, the process returns to step 1604 as before. This loop may continue until the customer decides that no deal can be made which is step 1614, no-close. In one embodiment, if the negotiation process is not advancing, then at step 1608, a typical four square sales system worksheet is displayed. FIG. 19 is an example of a four square worksheet. This approach enables the customer to fill in their desired values divided into four boxes which may include the trade-in value, purchase price, down payment, and monthly payment. The process continues to steps 1610, 1612 and 1602 where the customer may accept or reject the offer.

When the customer is satisfied with the offer, the process advances to step 1616 wherein the accepted offer is displayed. FIG. 17 illustrates acceptance button 1710. The system then advances to the ezPreFi™ module.

The negotiation portion of the method allows the customer to drive the sales process by providing the customer control of the payment options. This gives the customer functionality and flexibility for the payment options in order to fit their specific needs. It allows the customer to sell himself on the terms of sale and potentially shortens the time the customer spends at the dealership. This method is counterintuitive in the automobile sales industry because in this industry, the merchant representative normally strives to maintain the customer at the dealership as long as possible hoping to “break” the customer into a sale. Traditionally, the merchant representative is driving the sales process and pushing the sale on the consumer.

The ezPre-Fi™ alleviates the amount of time between the sales desk and the finance and insurance groups. FIG. 20 is a flowchart for an example embodiment of the ezPre-Fi™ module 2000. The ezMenu™ is the finance and insurance presentation tool. FIG. 21 depicts a flowchart for an example embodiment of the ezMenu™ module 2100.

After the customer has agreed to accept the offer, the process advances to the ezDelivery™ module which manages the car delivery process after purchase. FIG. 22 shows a flowchart for an example embodiment of the ezDelivery™ module 2200. The ezGrid™ module is run during the ezDelivery™ module. The steps for the ezGrid™ module are labeled 2201-2208. At the end of this process, the customer drives away in the newly purchased vehicle.

When service is needed on a vehicle, the method starts with the ezGreet™ module for a service/parts customer. FIG. 23 illustrates a flowchart for an example embodiment of the ezGreet™ module for a service/parts customer 2300. The ezService™ module automates the service repair order creation, tracking, and expediting. FIG. 24 illustrates a flowchart for an example embodiment of the ezService™ module 2400. The ezParts™ module is the service parts department application for automating the consumer purchase experience.

Other modules in the method are the ezMonitoring™ whereby real time security monitoring of dealership lot with remote accessibility through the ezDashboard is available. The ezBeBack™ which is the customer retention and marketing application. Direct branded advertising is delivered to customer automatically. The ezAccess™ module is the integration with third party dealer application providers, centralizing the interface for all.

Furthermore, the ezReporting™ module is real time reporting, from the beginning of the purchase process throughout ownership of the vehicle. Workflow and process adjustments can be made on the fly, to adjust to market needs and demands by all data subscribers. Reporting and analytics of the consumers buying behavior may be generated. Data mining and integrated infrastructure enabling tracking of data including behavior, time, location, demographics and industry feedback is also included. This allows real time reporting on data points across the entire consumer engagement. This data may be utilized to improve the consumer experience, monitor CSI, make adjustments to the organizations operations and accurately predict future buyer behavior patterns and market trends.

In further embodiments, the method provides an interior or exterior mounted camera on the device during customer use. The device is an internet enabled device including a smartphone, a tablet, a handheld computing device, a kiosk, a laptop or a desktop computer. In this way, the ocular activity such as eye movement, pupil dilation or the like may be monitored. Iris recognition or multi-biometrics may also be used. This data may be later analyzed for ocular activity versus provided responses by the customer.

In another application, the method may communicate with hardware installed in a vehicle. An external device available for purchase by the customer may plug into the hardware. A data package may be available for purchase or subscription to the customer with the device. Through this data package, the dealership or manufacture may communicate with the customer through the life of the vehicle regarding the vehicle. For example, vehicle software updates may be supported through the data package thus eliminating a visit to the dealership for service. General maintenance reminders or recall notices may be broadcast. The customer may track or monitor information such as driving patterns, braking patterns, gas mileage, trip history, and/or geographical location.

In a further embodiment, the method may communicate with hardware installed in a vehicle. For example, an external device may plug into the hardware on a vehicle. The vehicle may be new or used and available for sale by a dealership. The merchant representative or dealer may use this information for real-time inventory tracking purposes. Once the vehicle is purchased, the device may be transferred to the buyer or a data package may be available for purchase or subscription to the customer with the device as described above.

While the specification has been described in detail with respect to specific embodiments of the invention, it will be appreciated that those skilled in the art, upon attaining an understanding of the foregoing, may readily conceive of alterations to, variations of, and equivalents to these embodiments. These and other modifications and variations to the present invention may be practiced by those of ordinary skill in the art, without departing from the spirit and scope of the present invention. Furthermore, those of ordinary skill in the art will appreciate that the foregoing description is by way of example only, and is not intended to limit the invention. Thus, it is intended that the present subject matter covers such modifications and variations.

1. A computer-implemented method for a sale or lease of a vehicle the method comprising:
i) receiving, via a server, confirmation that an in-person meeting between a merchant representative and a buyer has occurred, the in-person meeting being for the sale or the lease of the vehicle;
ii) receiving inputs from the merchant representative initiating a transaction, the inputs being received from a device used by the merchant representative, the transaction being for the sale or the lease of the vehicle; and
iii) receiving second inputs for processing the transaction from both the merchant representative and the buyer;
iv) finalizing a negotiation between the merchant representative and the buyer;
wherein the second inputs from the merchant representative include a final price for the sale or final terms for the lease, the final price being different from a listed price, and the final terms being different from listed terms;
wherein the second inputs for processing the transaction facilitate the negotiation on sale or lease terms between the merchant representative and the buyer;
wherein a software application is used to facilitate the method, the software application having a primary focus of (a) facilitating the negotiation between the merchant representative and the buyer and (b) the finalizing of the negotiation; and
wherein the negotiation is an iterative process between the merchant representative and the buyer.

2. The computer-implemented method of claim 1, wherein the sale or lease terms include loan amount, finance arrangement, trade-in value, amount of cash deposit, extended warranties, accessories, parts, service, installations, repair work, maintenance or insurance.

3. The computer-implemented method of claim 1, wherein the device is an internet enabled device including a smartphone, a handheld computing device, a kiosk, a tablet, a laptop or a desktop computer.

4. The computer-implemented method of claim 1, wherein the merchant representative is located at a point of sale.

5. The computer-implemented method of claim 1, wherein the inputs are primarily provided electronically, online, wirelessly or telephonically.

6. The computer-implemented method of claim 1, wherein the in-person meeting occurs at a point of sale.

7. The computer-implemented method of claim 1, wherein the inputs are primarily provided at the point of sale.

8. The computer-implemented method of claim 1, wherein the software application interface is a web browser or smartphone application.

9. The computer-implemented method of claim 1, wherein the negotiation is primarily driven by the buyer.

10. The computer-implemented method of claim 1, further comprising:
iv) collecting new inputs from the buyer;
v) using psycho-analytics or logic based artificial intelligence to identify a need of the buyer based on the new inputs;
vi) analyzing the new inputs;
vii) identifying a product for sale or lease, the identifying being based at least in part on the new inputs;
viii) displaying the product for the buyer; and
ix) creating reports for the merchant representative, the creating being based at least in part on the new inputs.

11. The computer-implemented method of claim 10, wherein the collecting of the new inputs occurs in real time.

12. The computer-implemented method of claim 10, wherein the collecting of the new inputs occurs at a point of sale.

13. The computer-implemented method of claim 1, further comprising:
iv) collecting new inputs from the buyer;
v) using iris recognition or multi-biometrics to identify a need or desire of the buyer based on the new inputs;
vi) analyzing the new inputs;
vii) identifying a product for sale or lease, the identifying being based at least in part on the new inputs;
viii) displaying the product for the buyer; and
ix) creating reports for the merchant representative, the creating being based at least in part on the new inputs.

14. A non-transitory machine-readable medium including instructions executable by the machine for facilitating a negotiation for a sale or lease of a vehicle, the instructions causing the machine to:
i) receive, via a server, confirmation that an in-person meeting between a merchant representative and a buyer has occurred;
ii) receive inputs from the merchant representative initiating a transaction, the inputs being received from a device used by the merchant representative, the transaction being for the sale or the lease of the vehicle; and
iii) receive second inputs for processing the transaction from both the merchant representative and the buyer;
iv) finalize the negotiation between the merchant representative and the buyer;
wherein the second inputs from the merchant representative include a final price for the sale or final terms for the lease, the final price being different from a listed price, and the final terms being different from listed terms;
wherein the second inputs for processing the transaction facilitate the negotiation on sale or lease terms between the merchant representative and the buyer;
wherein a software application is used to facilitate with the non-transitory machine-readable medium, the software application having a primary focus of (a) facilitating the negotiation between the merchant representative and the buyer and (b) the finalizing of the negotiation; and
wherein the negotiation is an iterative process between the merchant representative and the buyer.

15. The non-transitory machine-readable medium of claim 14, wherein the sale or lease terms include loan amount, finance arrangement, trade in value, amount of cash deposit, extended warranties, accessories, parts, service, installations, repair work, maintenance or insurance.

16. The non-transitory machine-readable medium of claim 14, wherein the merchant representative is located at a point of sale.

17. The non-transitory machine-readable medium of claim 14, wherein the in-person meeting occurs at a point of sale.

18. The non-transitory machine-readable medium of claim 14, wherein the inputs are primarily provided at the point of sale.

19. The non-transitory machine-readable medium of claim 14, wherein the negotiation is primarily driven by the buyer.

20. The non-transitory machine-readable medium of claim 14, further comprising:
iv) collecting new inputs from the buyer;
v) using psycho-analytics or logic based artificial intelligence to identify a need of the buyer based on the new inputs;
vi) analyzing the new inputs;
vii) identifying a product for sale or lease, the identifying being based at least in part on the new inputs;
viii) displaying the product for the buyer; and
ix) creating reports for the merchant representative, the creating being based at least in part on the new inputs.

21. The non-transitory machine-readable medium of claim 20, wherein the collecting of the new inputs occurs in real time.

22. The non-transitory machine-readable medium of claim 20, wherein the collecting of the new inputs occurs at a point of sale.
